(19) United States
(12) Patent Application Publication
(10) Pub. No.: US 2025/0321127 A1
(43) Pub. Date: Oct. 16, 2025

(54) GRADIENT-BASED ABSOLUTE ENCODERS

(71) Applicant: Fisher Controls International LLC, Marshalltown, IA (US)

(72) Inventor: Eric Holmgren, Marshalltown, IA (US)

(21) Appl. No.: 18/637,202

(22) Filed: Apr. 16, 2024

(51) Int. Cl. G01D 5/26; G01B 7/30

(52) U.S. Cl. CPC G01D 5/264; G01B 7/30

(57) ABSTRACT

A gradient-based encoder mechanism for a rotary motor, linear motor, or other actuator can include a color sensor that measures a color at a certain point in front of the sensor. A scale in front of the sensor is encoded with different colors arranged to form one or more gradients. Each color represents a different absolute position of a shaft, screw, slide, belt, or other actuated element. Either the sensor or the scale is coupled to and moves with the actuated element. The other of the sensor or scale remains stationary. As a result, the color that is in front of the sensor changes as the actuated element moves. The color sensor outputs the color measurement to controller circuitry, which converts the color into an output signal representing the position of the actuated element. A combination rotary and linear encoder is also disclosed.

### FIELD OF THE DISCLOSURE

The present disclosure generally relates to encoders, and, more particularly, devices and techniques for gradient-based absolute encoders.

### BACKGROUND

Encoders are commonly utilized in systems actuated by motors or other mechanisms to determine and report positional information about the actuated element. Two general types of encoders are rotary encoders and linear encoders. Rotary encoders determine the angular position of a rotatable shaft or axle by using an electric sensor, magnetic sensor, transducer, or other mechanism to read information encoded in various forms on a rotary scale such as a disc and convert such information to angular position information. Linear encoders determine the linear position of an element along an axis by reading information in a similar manner from a linear scale, such as a slide, strip, or ruler, and converting such information to linear position information. An encoder may be incremental or absolute, the former determining how frequently a certain movement occurs (e.g., each revolution of the actuated element), and the latter determining an exact angular or linear position of the actuated element.

There are a variety of technologies that an encoder may utilize to read information from a rotary or linear scale, each of varying cost, complexity, and precision. For example, an encoder may determine position information utilizing conductive contacts that follow circumferential or linear tracks on a scale, or electromagnetic coils or sensors that sense changes in a magnetic field. As another example, an optical encoder may determine position utilizing an optical sensor to detect light passing through slits in a metal or glass scale, or reflected from such a scale.

With many absolute encoding technologies, the scale comprises multiple tracks of parallel lines or concentric circles, where each track may at any given position be “on” or “off,” thus producing a readout having as many bits as there are tracks. These bits collectively encode the position of the actuated element. One common type of encoding for such position information is known as a Gray code. A variety of other encoding schemes and encoder mechanisms also exist.

### SUMMARY

Inventive gradient-based optical encoder mechanisms and related techniques are now described with respect to various example embodiments. Among other applications, the devices and techniques provide relatively high positional granularity with less complexity or at less expense than existing techniques. Moreover, in some embodiments, the devices and techniques do not involve contact or close proximity between the encoder sensor and scale, reducing potential sources of friction or wear over time that may be found in certain other techniques.

According to an embodiment, a rotary encoder assembly comprises: a shaft rotatable around a first axis; a scale comprising a color wheel that represents absolute angular positions relative to a point at which the first axis intersects the color wheel, the color wheel having at least one gradient between colors, each color in the gradient corresponding to a different angular position; a color sensor configured to measure a color of the color wheel at a particular position in front of the color sensor; and a controller configured to output an angular position signal representing an angular position of the shaft based on the color measured by the color sensor.

In an embodiment, the assembly further comprises an electrical motor, the shaft coupled to a rotor of the motor.

In an embodiment, the color sensor is coupled to the shaft and thereby configured to rotate with the shaft while the color wheel remains stationary relative to the first axis, such that the particular position measured by the color sensor changes as the shaft rotates.

In an embodiment, the scale is coupled to the shaft and thereby configured to rotate with the shaft while the color sensor remains stationary relative to the first axis, such that the color of the color wheel at the particular position measured by the color sensor changes as the shaft rotates.

In an embodiment, angular positions represented by the gradient increase as the gradient progresses from a first color to a second color.

In an embodiment, the color wheel comprises a first gradient between a first color and a second color, a second gradient between the second color and a third color, and a third gradient between the third color and the first color.

In an embodiment, the color wheel comprises a first arc having a first gradient between a red color and a green color, a second arc having a second gradient between the green color and a blue color, and a third arc having a third gradient between the blue color and the red color.

In an embodiment, the first arc, the second arc, and the third arc are each adjacent to each other and span all three-hundred and sixty degrees of the color wheel.

In an embodiment, the color sensor is configured to output to the controller an indication of the color at the particular position as a measurement in a color space comprising at least three components; wherein the controller is configured to convert the measurement into the angular position based on a mapping from the color space to a polar angle.

In an embodiment, the color wheel further comprises a reference patch based on which the color sensor or the controller normalizes the measurement.

According to an embodiment, a linear encoder assembly comprises: a linearly actuatable element movable along a first axis; a color scale representing absolute linear positions on a line segment that is parallel to the first axis, the color scale having at least one gradient between colors, each color of a plurality of colors in the gradient corresponding to a different linear position; a color sensor configured to measure a color of the color scale at a particular position in front of the color sensor; and a controller configured to output a linear position signal representing a linear position of the linearly actuatable component based on the color measured by the color sensor.

In an embodiment, the assembly further comprises a linear actuator coupled to the linearly actuatable element, the linear actuator configured to cause movement of the linearly actuatable element along the first axis.

In an embodiment, the color sensor is coupled to or included in the linearly actuatable element and thereby configured to move along the first axis with the linearly actuatable element while the color scale remains stationary relative to the first axis, such that the particular position measured by the color sensor changes as the linearly actuatable element moves along the first axis.

In an embodiment, the color scale is coupled to or included in the linearly actuatable element and thereby configured to move along the first axis with the linearly actuatable element while the color sensor remains stationary relative to the first axis, such that the color of the color scale at the particular position measured by the color sensor changes as the linearly actuatable element moves.

In an embodiment, linear positions represented by the gradient increase as the gradient progresses from a first color to a second color.

In an embodiment, the color scale comprises a first gradient between a first color and a second color, a second gradient between the second color and a third color, and a third gradient between the third color and the first color.

In an embodiment, the color scale comprises a first segment having a first gradient between a red color and a green color and a second segment having a second gradient between the green color and a blue color.

In an embodiment, the color sensor is configured to output to the controller an indication of the color at the particular position as a measurement in a color space comprising at least three components; wherein the controller is configured to convert the measurement into the linear position based on a mapping from the color space to a measure of distance from an origin.

According to an embodiment, a combination linear and rotary encoder assembly comprises: a shaft that is both rotatable around a first axis and movable along a length of the first axis, the shaft having an exterior surface colored in such manner that each surface position of a plurality of surface positions has a unique color; a color sensor configured to measure a color of the exterior surface at a particular position in front of the color sensor; and a controller configured to, based on the color measured by the color sensor, output a position signal representing a coordinate of the shaft in terms of both angular position relative to the first axis and linear position along the first axis.

In an embodiment, the controller is configured to calculate the angular position based on a color coordinate of the color in a color space; wherein the controller is configured to calculate the linear position based on a color appearance parameter in a color appearance model.

In an embodiment, the color appearance parameter is one of hue, lightness, brightness, chroma, colorfulness, saturation, or contrast.

In an embodiment, at each angular position of a plurality of angular positions relative to the first axis, the exterior surface is colored a shade of a particular color mapped to that angular position, the shade increasing in one or more or intensity, brightness, luminance, or lightness in accordance with distance from an origin along the first axis.

In an embodiment, the particular color mapped to each angular position of the plurality of angular positions progresses in a gradient from a first color to a second color as the angular position increases from a first position to a second position.

In an embodiment, for each cross-section of a plurality of horizontal cross-section of the shaft, the exterior surface indicates angular positions using at least one gradient, in which the angular positions increase as the gradient progress from a first color to a second color; wherein each cross-section has a different first color and a different second color, selected from a first color appearance gradient and a second color appearance gradient, respectively, based on a linear position of the cross-section along the first axis.

In an embodiment, the first color appearance gradient and the second color appearance gradient are progressions of a first base color and a second base color, respectively, as one or more color appearance parameters gradually change, the one or more color appearance parameters including at least one of: hue, lightness, brightness, chroma, colorfulness, or saturation.

In an embodiment, each angular position in a plurality of angular positions in a first arc of the exterior surface is mapped to a different color in a first gradient from a red color to a green color; wherein each angular position in a plurality of angular positions in a second arc of the exterior surface is mapped to a different color in a second gradient from the green color to a blue color; wherein each angular position in a plurality of angular positions in a third arc of the exterior surface is mapped to a different color in a third gradient from the blue color to the red color; wherein locations on the exterior surface are colored with shades of the colors that are mapped to the angular positions of those locations, the shades progressing in brightness, intensity, or lightness with the linear positions of those locations.

### BRIEF DESCRIPTION OF THE DRAWINGS

The present inventive subject matter is illustrated by way of example, and not by way of limitation, in the figures of the accompanying drawings and in which like reference numerals refer to similar elements and in which:

FIG. 1 is an illustrative view of an example fixed sensor gradient-based rotary encoder mechanism;

FIG. 2A illustrates an example color-to-position mapping table;

FIG. 2B illustrates a graph of an example mapping scheme in which position is a function of a color measurement;

FIG. 3 is an illustrative view of an example fixed sensor gradient-based rotary encoder mechanism, according to an embodiment;

FIG. 4 is an illustrative view of an example fixed scale gradient-based linear encoder mechanism;

FIG. 5 is an illustrative view of an example fixed sensor gradient-based linear encoder mechanism;

FIG. 6 is an illustrative view of an example combination rotary and linear encoder mechanism; and

FIG. 7 is a block diagram 700 illustrating an example process flow for utilizing a gradient-based encoder.

### DETAILED DESCRIPTION

According to certain embodiments, a gradient-based encoder mechanism includes a color sensor that measures a color at a certain point in front of the sensor. A scale, which may be rotary or linear depending on the embodiment, is placed in front of the sensor, for instance on a plane that includes this point. The scale is encoded with different colors that the color sensor may read, each color representing a different position of an actuated element. The actuated element may be, for instance, a shaft attached to a rotary motor, a rack actuated by a pinion, a screw, a belt, or any other suitable element. Depending on the embodiment, either the sensor or the scale is coupled to and moves with the actuated element. The other of the sensor or scale remains stationary. As a result, the color that is in front of the sensor changes as the actuated element moves. The color sensor outputs the color measurement to controller circuitry, which converts the color into an output signal representing the position of the actuated element.

According to certain embodiments, the scale employs one or more gradients to represent position information. For instance, a gradient from red to blue may be printed on the scale. As the position of the actuated element increases, the color on the scale progresses from red to blue. Rather than being limited to a small set of colors, positions may be represented by an entire spectrum of colors, limited only by the granularity at which the scale can represent that spectrum and the ability of the color sensor to distinguish between adjacent colors in the spectrum. In an embodiment, more than one gradient may be used in a scale to increase granularity.

These and other techniques and mechanisms are now described in greater detail with respect to example encoders for detecting angular positions, linear positions, or combinations thereof.

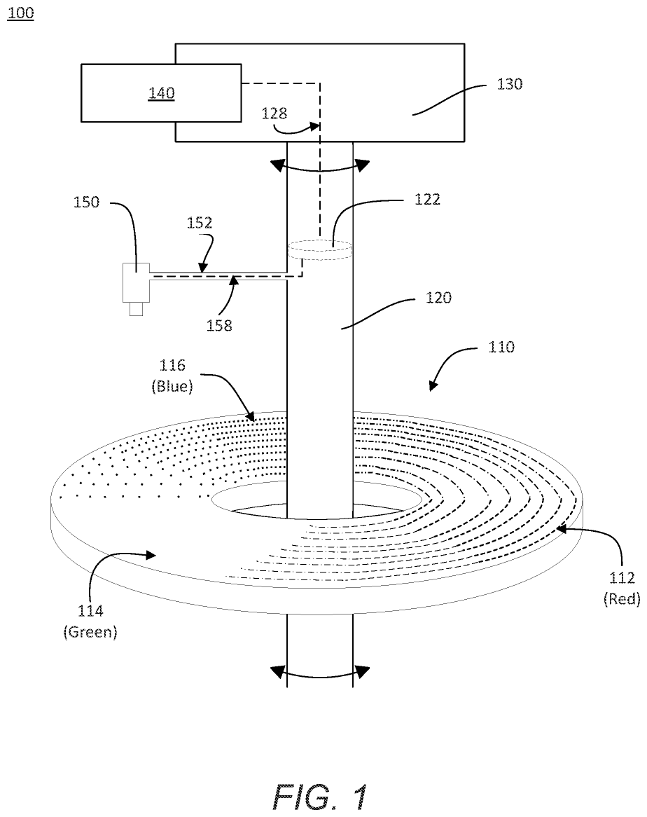

Some examples can provide a fixed scale rotary encoder. For example, FIG. 1 is an illustrative view of an example fixed sensor gradient-based rotary encoder mechanism 100, according to an embodiment. Encoder mechanism 100, also referred to simply as encoder 100, is utilized to determine the absolute angular position of a shaft 120, which may rotate in a clockwise or counter-clockwise direction around an axis that is vertical relative to the illustrative view. Although not depicted, encoder 100 (or any other encoder described herein) may optionally form part of an assembly that includes housing that partially or wholly encloses encoder 100, as well as various other electrical and structural components. In some embodiments, a portion of shaft 120 may partially protrude from such housing.

Shaft 120 is a substantially cylindrical element, such as a pole, screw, axle, or rod, that is elongated along its vertical axis. In some embodiments, shaft elements that are not purely cylindrical may be utilized for shaft 120, including without limitation notched shafts, hexagonal shafts, square shafts, and so forth. Shaft 120 may in turn be coupled to, and cause rotation of, other elements (not depicted).

An actuator 130 coupled to shaft 120 causes shaft 120 to rotate. Actuator 130 may be of electrical, mechanical, hydraulic, pneumatic, magnetic, or any other suitable actuating means, depending on the embodiment. For example, in an embodiment, actuator 130 comprises a gearbox coupled to a rotary motor such as, without limitation, a brushed or brushless DC motor, brushless AC motor, AC induction motor, stepper motor, or servo motor.

Various rotary scales are possible. For example, encoder 100 comprises a rotary scale 110 with color markings. Rotary scale 110, or simply scale 110, surrounds shaft 120, or more specifically a cross-segment of the shaft 120. Scale 110 may be a substantially two-dimensional medium formed from any substantially rigid material, such as plastic, metal, wood, cardboard, card stock, and so forth, whose plane is perpendicular to the rotational axis of shaft 120. For instance, rotary scale 110 may be a washer-shaped annular disc.

Scale 110 is not directly attached to shaft 120. Rather, there is a gap between shaft 120 and the interior edge of scale 110 to allow shaft 120 to rotate independently of scale 110. That is, scale 110 is stationary relative to shaft 120 and remains in a fixed position while shaft 120 rotates. Scale 110 may be held in its fixed position using any suitable means. For example, in an embodiment, scale 110 may have a peripheral edge that is set within a circumferential groove in a structure that at least partially surrounds encoder 100. As another example, a raised exterior lip along the periphery of scale 110 may be attached by fasteners, adhesives, or tension to such a structure. In an embodiment, sensor 150 may face an interior surface of a housing for encoder 100, on which scale 110 is attached or in which scale 110 is formed.

Scale 110 has a top surface which has been painted, printed, inscribed, or otherwise formed with color markings that vary in accordance with the polar angles of those markings relative to the rotational axis of shaft 120. The color markings are radial in nature and may be said to form a color wheel. Circumferentially, the markings are arranged to form color gradients around the wheel. The gradients transition between primary colors 112, 114, and 116. Specifically, the markings form a total of three gradients, between a red color 112 (depicted as densely spaced half-dashes) positioned at an absolute angle of 0 degrees, a green color 114 (depicted as white) positioned at an absolute angle of 120 degrees, and a blue color 116 (depicted as densely spaced dots) positioned at an absolute angle of 240 degrees.

Each color in each gradient is a different mixture of the starting and ending primary colors 112-116. The similarity of the color of a marking to a given primary color 112-116 grows with proximity to that primary color 112-116. This scheme is depicted in FIG. 1 using different combinations of interspersed primary color markings 112-116 (i.e., half-dashes, dots, and white space) to represent each color in a gradient, in which the proportion of markings for a given primary color 112-116 grow with proximity to that primary color 112-116. Each of these colors forms a different wedge, or sector, marking on scale 110. The amount of each constituent primary color 112-116 mixed to form a given color in a gradient, as well as the rate at which a gradient progresses between primary colors 112-116, may vary depending upon the embodiment. For simplification, only a few colors are illustrated, and it will be understood that there may be many more colors in each gradient, depending on the embodiment.

Scale 110 is but one example of a gradient-based rotary scale. Other suitable gradient-based rotary scales may be of different widths and thicknesses, having various gaps between the inside of scale 110 and shaft 120. For instance, in an embodiment, scale 110 may be more of a thin ring shape rather than a washer shape. In an embodiment, scale 110 need not necessarily surround shaft 120 itself, but rather may be positioned on any plane perpendicular to the axis around which shaft 120 rotates. For instance, scale 110 may be a circular scale, as opposed to an annular disc, that is affixed to a surface situated beyond the end, or top surface, of shaft 120, such that the center of the circle falls substantially on the axis around which shaft 120 rotates.

While the color markings of scale 110 are radial, the medium on or in which those markings are formed need not be circular in shape. For example, scale 110 may be formed on a rectangular medium so that it may more easily be embedded within a rectangular housing. The color markings may or may not cover the entire medium—for instance, the markings may cover only a disc around the mid-point of a rectangular medium. In yet another embodiment, scale 110 need not be planar or reside substantially within a plane perpendicular to shaft 120. For instance, scale 110 may conform to the contours of the inside of a cone or other non-planar surface to which it has been attached or in which it has been embedded.

As additional variations, in an embodiment, scale 110 is formed by placing a sticker or other adhesive label with suitable color markings on a disc or on an interior surface that faces the sensor 150. In another embodiment, the color markings in scale 110 may be colored panels made of translucent or semi-transparent glass, glass, plastic, paper, or other suitable material.

Moreover, the color marking scheme for scale 110 may vary in other embodiments, as described in other sections.

One or more sensors can be used in different implementations. For example, encoder 100 further comprises a sensor 150. Sensor 150 is attached to, and rotates with, shaft 120. Sensor 150 is situated facing scale 110 so that sensor 150 may read, capture, sense, or otherwise detect the colors of the markings on scale 110. Sensor 150 is more particularly attached to shaft 120 by means of an arm element 152. Wiring 128/158 electronically couples sensor 150 to a controller 140 for communication purposes, as well as to a power supply (undepicted). Wiring 128 is routed through shaft 120 to a slip ring 122 embedded within shaft 120, while wiring 158 is routed from slip ring 122 through arm 152 and to sensor 150. Of course, any other suitable mechanism for wiring sensor 150 may be used, including without limitation commutators, rotary transformers, and so forth. In another embodiment, no wiring between sensor 150 and controller 140 is needed. Instead, a wireless communication mechanism and battery or wireless power source may be utilized.

While sensor 150 is depicted as facing away from actuator 130 and the base of shaft 120, and scale 110 is depicted as facing towards them, it will be understood that this positioning may be reversed both in the embodiment of FIG. 1 and in other embodiments. For instance, scale 110 may be formed on a surface at the base of shaft 120, facing towards a sensor 150 that in turn faces the base.

Sensor 150 may be any suitable type of color-detecting device. For instance, sensor 150 may be as simple as a set of one or more photoresistors, phototransistors, or photodiodes, adapted for use with red, green, and blue color filters. Or sensor 150 may take more complex forms, such as a color camera, colorimeter, spectrometer, and so forth.

In an embodiment, sensor 150 may include or be coupled to a light source, such as a light-emitting diode or lamp, that is situated in such a manner as to cause light to reflect off of, or pass through, scale 110. This light may be received by sensor 150, and sensor 150 may sense the color thereof. In other embodiments, there may be sufficient ambient light available from other sources so that sensor 150 does not need its own light source.

The distance between sensor 150 and scale 110 may vary depending on the embodiment. The optical characteristics and placement of sensor 150 may be fixed so that the portion of scale 110 that is directly in front of sensor 150 will always be in focus or otherwise readable. Or sensor 150 may have one or more adjustable characteristics, such as aperture, exposure, focal length, and so forth, or an adjustable placement, by which the distance between sensor 150 and scale 110 may be adjusted for use in reading the scale 110. While scale 110 is depicted as being perpendicular to the orientation of sensor 150, in other embodiments sensor 150 may be oriented at other angles relative to scale 110, so long as sensor 150 remains capable of reading the relevant color markings on the scale 110.

Sensor 150 is configured to determine a color of the light it receives from scale 110 and output information, collectively referred to as a color measurement, indicating that color. Sensor 150 may do so using any suitable means. For example, sensor 150 may measure an amount of light being received through different color filters (e.g., red, green, and blue) either by a single photocell in rapid succession, or by different photocells concurrently. Sensor 150 may pass analog voltage signals corresponding to these measurements directly out wiring 158/128. Or sensor 150 may convert such analog signals into digital values representing the amount of light received in each color of a particular color space (e.g., red, green, and blue). The digital values may be combined into a single digital output signal, for instance a six-digit hexadecimal number in which red, green, and blue are each represented by two of the digits, which sensor 150 sends through wiring 158/128.

In embodiments where sensor 150 is a more complex device, such as a camera, sensor 150 may “read” or otherwise sense colors at multiple points (e.g., dots, pixels, portions, sections, etc.) on the scale 110. Sensor 150 may be configured to average, compute the mode or median of, or otherwise mathematically manipulate the measured colors together to form a single color measurement, which is said to correspond to the color that is currently detected by (i.e. “in front of”) the sensor 150. For instance, sensor 150 may capture a digital image in a digital image format (e.g., RAW, TIFF, JPEG, etc.), determine an average or median color across the entire image, and output a color measurement of that color. Sensor 150 may optionally crop or filter certain regions of the image before performing said averaging, for instance to remove areas of the image that do not have markings, are not central to the image, do not belong to the most central patch or gradient of colors, have outlying or unexpected colors, or for other reasons.

In other embodiments where sensor 150 is a more complex device, the logic for performing such averaging and filtering may instead reside downstream on the controller 140, or an intermediary logic component deployed between the sensor (e.g., camera) 150 and controller 140. Sensor 150 may simply output to the wire 158 an image or other collection of color measurements, which for purposes of this disclosure is said to be color information that indirectly indicates the color detected by the sensor 150. A more specific value of the color detected by the sensor 150 is then calculated by the downstream logic to form a color measurement suitable for processing by the controller 140.

Of course, sensor 150 may instead utilize any other suitable color sensor mechanism to detect and communicate a color to the controller 140.

One or more controllers can be used in some implementations. For example, encoder 100 further comprises a controller 140. Controller 140 is configured to determine the absolute angular position of shaft 120 based on the color measurement from sensor 150. Controller 140 generally comprises computing hardware or other circuitry configured to input data signals from sensor 150 and determine an absolute position, also referred to herein as a position value or encoder position, that corresponds to the inputted data. For instance, controller 140 may comprise a microcontroller, microprocessor, general purpose processor, Application-Specific Integrated Circuit, or Field-Programmable Gate Area configured to execute software or hardware-based instructions to accomplish the foregoing. In yet other embodiments, controller 140 may comprise analog circuitry configured to transform color measurement signals into signals representing position values.

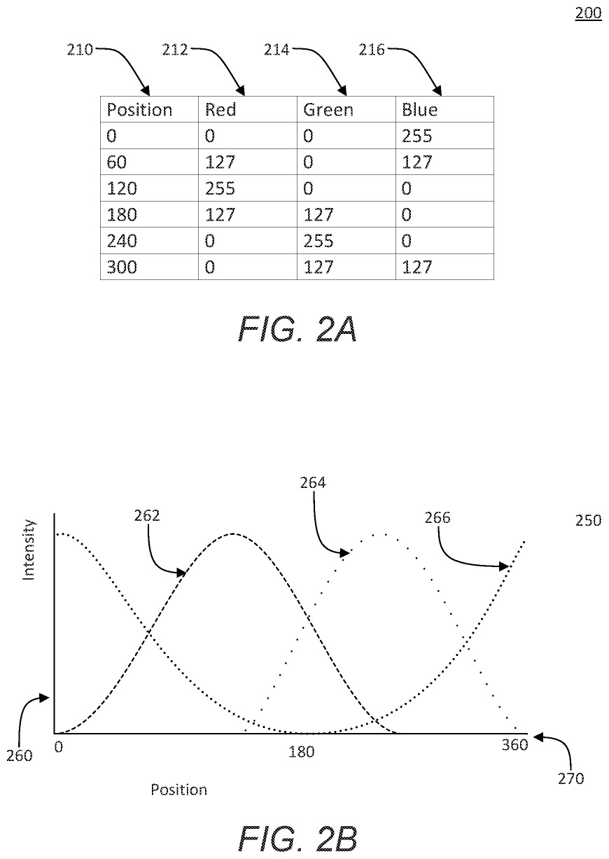

In an embodiment, controller 140 is configured to transform color measurement signals into position values in accordance with a mapping scheme, such as a table or mapping function that mirrors the scheme used to determine colors for scale 110. For example, FIG. 2A illustrates an example color-to-position mapping table 200, according to an embodiment. Table 200 includes position column 210, red column 212, green column 214, and blue column 216. Each row in the table 200 indicates, for the polar angle specified in position 210, what the corresponding color measurement should be in terms of the primary colors red, green, and blue, which correspond to columns 212, 214, and 216, respectively. Of course, there may be many additional rows in table 200, depending on the embodiment.

In an embodiment, mapping table 200 is a table in a memory or storage within or otherwise coupled to controller 140. Such a table may be hard-coded or may be calibrated to the specific encoder 100 as needed. In an embodiment, once controller 140 has a color measurement, controller 140 locates the row in table 200 whose color columns 212-216 match, or most closely match, the color measurement, and returns the corresponding position 210. In an embodiment, if a color measurement fails to exactly match a specific row, instead of simply returning the most closely matched row, controller 140 may interpolate a position 210 for the color measurement from table 200 using any suitable technique.

In an embodiment, rather than utilizing a stored table such as table 200, controller 140 may calculate a position using a function of the color measurement. Such a function may be chosen so as to produce results similar to those found in table 200, depending on the embodiment. FIG. 2B illustrates a graph 250 of one such function. The output position is illustrated along x-axis 270. The output position is a function of the intensity of each primary color 262, 264, and 266, as plotted against the y-axis 260.

In yet other embodiments, a table 200 or mapping function need not be explicitly stored at the controller 140, but rather the mapping scheme is implemented by the controller 140 through other means. For instance, hard-coded logic or analog circuitry may output a position value based on a color measurement in a manner that is consistent with table 200 or graph 250 without requiring actual storage of such a table 200 or mapping function.

Controller 140 is generally configured to output an indication of the detected position value to another device or send an instruction to another device based on the determined position value. For example, controller 140 may be configured to output the position value directly or indirectly to an external controller device, such as an edge controller, data collector, Programmable Logic Controller (“PLC”), or motion driver, to which it is hard-wired. Or controller 140 may output the position value to a hard-wired network interface, which sends the position value to a remote controller device. For instance, controller 140 may be configured to output the position value using signals conforming to Serial Peripheral Interface (“SPI”), RS-485, Synchronous Serial Interface (“SSI”) or any other suitable protocol.

The external controller device may, in some embodiments, comprise or implement logic for controlling the actuator 130 based on the determined position value. For instance, the external controller device may comprise logic for moving shaft 120 to a particular position, and may utilize the determined position value to decide the direction and speed of movement that the controller device should instruct actuator 130 to take to reach that particular position. Or the external controller device may utilize the position value to generate a visual report or display on which the position of the shaft is depicted using numerical or other indicators.

As another example, in an embodiment, controller 140 may be electronically coupled to actuator 130. Controller 140 may itself include logic for instructing or otherwise causing actuator 130 to stop moving shaft 120 once the position value has reached or surpassed a particular position (e.g., a position requested by another device that is directly or indirectly communicatively coupled to the controller 140). Alternatively, controller 140 may be configured to output the position value to actuator 130, or to an embedded controller (not depicted), which may comprise similar logic for stopping movement of the shaft 120 once a desired position has been reached.

In yet other embodiments, the controller 140 may output the position value to any other suitable type of device, which may use the position value for any other control or reporting purposes.

Various color marking schemes are possible. In particular, the color marking scheme illustrated in FIG. 1 comprises two gradients between the three primary colors, red, green, and blue. Many variations on the color marking scheme may be employed in scales for this and other embodiments, both radial and linear, described throughout this disclosure.

For example, the mapping of primary colors to absolute positions may differ. The red color 112 in FIG. 1 may, for instance, be mapped to 120 degrees, 180 degrees, or any other polar angle. The primary colors 112-116 need not be distributed evenly across the scale 110. Red color 112 may be, for instance, 200 units from green color 114 but only 80 units from blue color 116.

As a corollary, the mappings of the non-primary colors in each gradient (e.g., between each primary color 112-116) to positions may likewise differ. Moreover, the number of colors in each gradient may vary depending on a variety of factors, such as the desired resolution of the encoder mechanism, the granularity at which colors may be formed, the resolution of the sensor being utilized, or the sensitivity of the sensor.

The primary colors may also be different than red, green, and blue. For instance, cyan, magenta, and yellow may be the primary colors. There may also be a greater or smaller number of primary colors than three, which would increase or decrease the number of gradients used. For instance, a scale might use four primary colors, such as cyan, magenta, yellow, and black. However, the primary colors need not necessarily be primary within any color model-gradients between any two arbitrary colors may be utilized. In an embodiment, a scale may consist of a single gradient between two primary colors, such as between red and blue, or black and white.

In an embodiment, the colors used for the markings are defined using a coordinate system in a color model, such as a red, green, and blue coordinate system or a hue, saturation, value coordinate system. A gradient between two primary colors in a scale may be formed by traversing a color model between the coordinates of those primary colors with a line, curve, or other defined path. The progression of colors in the gradient may be determined by sampling the color coordinates of the path at as many intervals as there are markings in the gradient.

In some embodiments, the color markings may be discrete patches of a same or similar color. Each patch is centered on or otherwise placed at the position (e.g., absolute polar angle, x-coordinate, etc.) to which the color of the patch corresponds. The patches are ordered in such a manner as to form gradients between primary colors. Such patches may take any of a variety of shapes, including circles, rectangles, wedges, sectors, arc segments, and so forth. The space between patches may or may not be “empty” (e.g., colored white or a common “background color”). In one rotary scale embodiment, the color patches may be fixed-width line segments, or bars, extending outwards radially, with each line segment centered on the absolute angle to which the line segments correspond.

In some embodiments, the color markings may be substantially contiguous gradients. The scale may be divided into units, referred to herein as dots, at a granularity selected based on a variety of factors, such as printer resolution (e.g., dots per inch), the number of colors that a printer is able to print, sensor resolution and sensitivity, and so forth. Each dot has a different color depending on its position. For instance, the color of a dot may be selected using a function of its nominal position (e.g., the position that corresponds to its mid-point).

In some embodiments, there may be just a single “row” of dots or patches. In rotary scales, such a row may form a circle that is concentric with the scale. In linear scales, such a row may form a horizontal line segment parallel to the movement of the actuated element. In other embodiments, there may be multiple rows. The rows may, but need not necessarily, be exactly the same in dot or patch spacing, offset, and so forth. In some rotary scale embodiments with multiple rows, the number of dots (or patches) in a row increases with the row's distance from the center of the scale. Hence, the gradients may become more granular for rows further from the center, such that there are more colors in the markings along the outer rim of the rotary scale than there are along the inner rim.

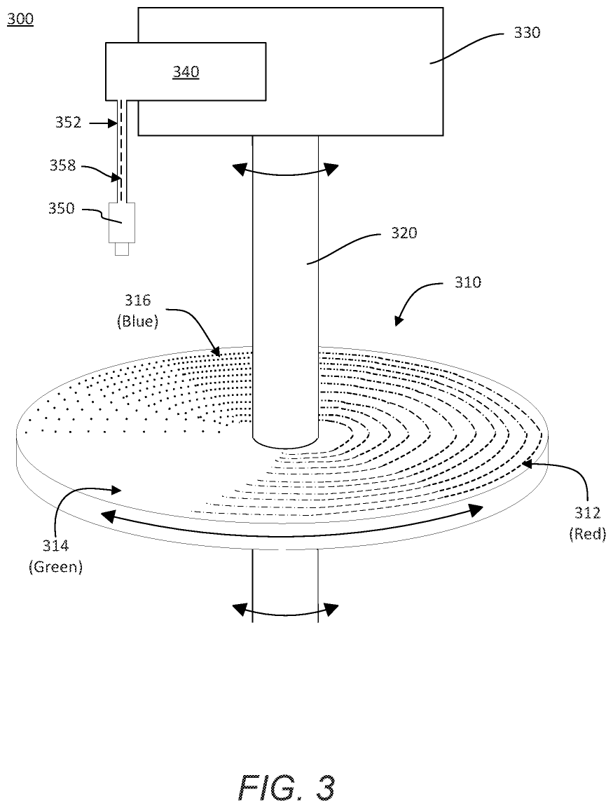

Some examples can utilize a fixed sensor rotary encoder. For example, FIG. 3 is an illustrative view of an example fixed sensor gradient-based rotary encoder mechanism 300, according to an embodiment. Encoder mechanism 300, or simply encoder 300, is utilized to determine the absolute angular position of a shaft 320, which is similar to shaft 120. Encoder 300 includes a sensor 350, scale 310, and controller 340, each similar to sensor 150, scale 110, and controller 140, respectively.

Shaft 320 is actuated by actuator 330, which is similar to actuator 130. However, unlike shaft 120, shaft 320 is directly coupled to a rotary scale 310 instead of a sensor 350. Scale 310 may be attached to shaft 320 by any suitable means. Scale 310 rotates with shaft 320. Scale 310 is otherwise like scale 110, including in that scale 310 is covered with colored markings arranged as gradients between primary colors 312-316.

Sensor 350 is stationary relative to shaft 320, but otherwise similar to sensor 150, including in that sensor 350 faces the color markings on the scale 310. As depicted in FIG. 3, sensor 350 is physically coupled to controller 340 by means of an arm 352. Wiring 358 routed through the arm 352 communicatively couples sensor 350 to controller 340. However, in other embodiments, sensor 350 may be held in its stationary position by any other suitable means, such as by physical attachment to actuator 330 or to a housing in which encoder 300 is embedded. Likewise, wiring 358 may be routed to controller 340 in any suitable manner.

In the same manner as sensor 150, sensor 350 is configured to read or otherwise detect the color of scale 310 at a point directly in front of sensor 350. Due to the rotation of scale 310 with the shaft 320, the color read by sensor 350 will change depending on the absolute angular position of the shaft 320. Sensor 350 sends an indication of the detected color to controller 340, just as sensor 150 sends an indication of the detected color to controller 140. Controller 340 then determines the position of the shaft 320 based on the detected color. Also as with controller 140, controller 340 may then output this position to another component that is coupled internally or externally to controller 340 or perform any of a variety of other actions based on that position.

### Fixed Scale Linear Encoder

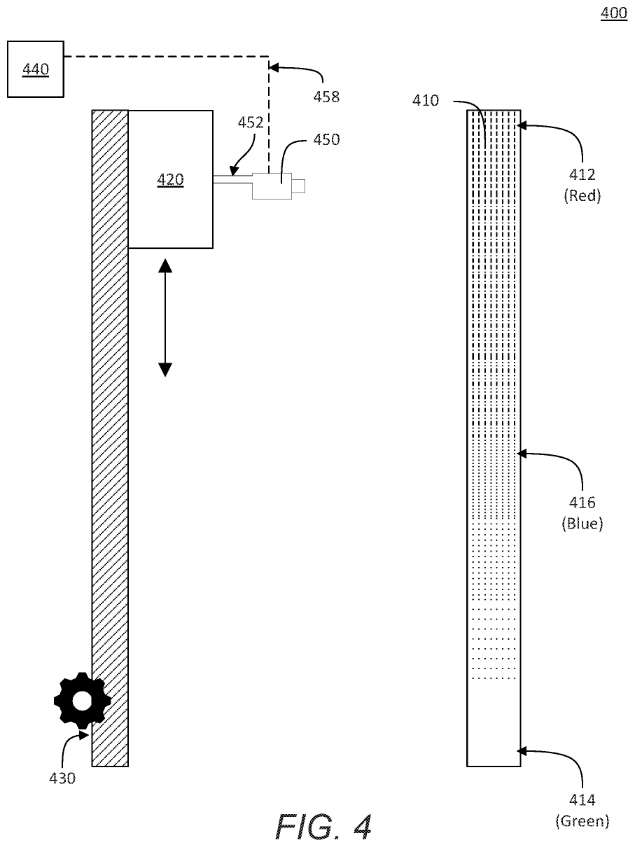

FIG. 4 is an illustrative view of an example fixed scale gradient-based linear encoder mechanism 400, according to an embodiment. Encoder mechanism 400, or simply encoder 400, is utilized to determine the absolute position of a linearly actuated element 420. Linearly actuated element 420, or simply actuated element 420, may be any sort of component, assembly, mechanism, or device that is linearly actuated by an actuator 430. Actuated element 420 is configured to move over a range of positions along a linear axis that is vertical to FIG. 4. Actuated element 420 is physically coupled, via an arm 452 or other structural element, to a sensor 450 that moves with actuated element 420.

As depicted, actuator 430 is a rack and pinion. The actuated element 420 is physically coupled to the rack, while the pinion is in turn controlled by rotary actuating means such as a rotary motor. However, actuator 430 may in fact be any sort of a linear actuator, including without limitation a chain drive, belt drive, any other wheel and axle actuator, screw actuator, cam actuator, hydraulic actuator, pneumatic actuator, linear motor, elector-mechanical actuator, and so forth. Although actuated element 420 is depicted as being a separate element attached to the actuator 430, actuated element 420 may in fact be part of the actuator 430, such as a rack, roller screw, hydraulic cylinder, and so forth. For instance, sensor 450 may be attached directly to a particular portion of a rack to measure the absolute position of that portion of the rack.

Encoder 400 comprises a fixed scale 410, which is in some respects similar to scale 110, in that color markings representing absolute positions have been printed, painted, inscribed, or otherwise formed in or on scale 410. Further like scale 110, the color markings are arranged to form gradients between primary colors 412-416. However, unlike scale 110, scale 410 is a linear scale. As such, scale 410 is a substantially rectangular medium on which the color markings are arranged linearly rather than radially. While each color marking still corresponds to a different position, those positions represent the linear distance of the actuated element 420 from an origin position, rather than angular position. Because the colors do not circle back around on themselves, scale 410 features just two gradients, between primary colors red 412 and green 414, and between green 414 and blue 416. Scale 410 is at least as long as the distance which actuated element 420 may travel. Scale 410 may indicate positions in millimeters, inches, meters, or any other suitable unit.

In contrast to the actuated element 420, scale 410 is held in a fixed, stationary position within the encoder 400. As with scale 110, scale 410 may be fixed in its position using any suitable means, such as by attachment to, or being formed in, the interior wall of an assembly in which encoder 400 is at least partially housed. Of course, scale 410 may take a variety of other forms so long as scale 410 provides substantially linear color markings that can be read by sensor 450.

Encoder 400 further comprises sensor 450, which is similar to sensor 150. Sensor 450 is oriented towards scale 410. Sensor 450 is focused on, or otherwise configured to detect, the color of a marking on scale 410 that is situated at a predefined point within the field of view of sensor 450. As actuated element 420 and sensor 450 move, the marking at this predefined point changes, and sensor 450 therefore detects a different color. Like sensor 150, sensor 450 is configured to output an indication of this color via a wire 458. Sensor 450 is oriented so that a different portion of scale 410 is in its view throughout the range of positions in which actuated element 420 is configured to move.

Encoder 400 further comprises controller 440, which is coupled to wire 458 and configured to receive color information from sensor 450. Controller 440 may be physically situated within actuated element 420, in or coupled to the actuator 430, or in any other suitable location. Generally, controller 440 converts the indication of color received from the sensor 450 into a corresponding encoder position that is mapped to that color. While the structure and operation of controller 440 is similar to that of controller 140, controller 440 may of course utilize or implement a different mapping scheme than controller 140. That is, controller 440 maps the inputted color information to linear positions as opposed to angular positions. Controller 440 may then output the determined encoder position to a downstream component or perform any of a variety of actions based on that position, as described with respect to controller 140.

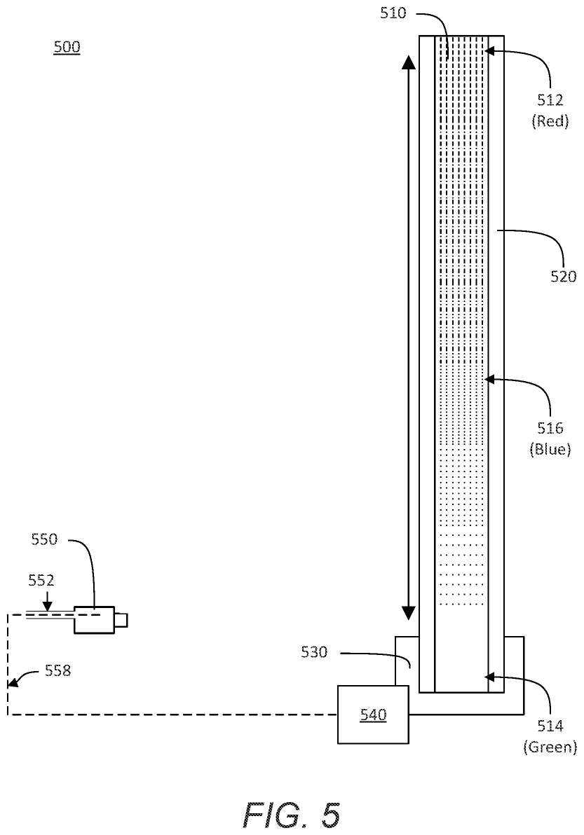

Some examples can use a fixed sensor linear encoder. For example, FIG. 5 is an illustrative view of an example fixed sensor gradient-based linear encoder mechanism 500, according to an embodiment. Encoder mechanism 500, or simply encoder 500, is utilized to determine the absolute position of a linearly actuated element 520. Similar to actuated element 420, actuated element 520 is configured to move over a range of positions along a linear axis that is vertical to FIG. 5. Actuated element 520 is actuated by an actuator 530, like actuator 430, which may be any type of linear actuator. Actuated element 520 may be a moving component of actuator 530 itself, such as a screw, rod, chain, or belt, or may be physically coupled to such a moving component.

Encoder 500 comprises a linear scale 510 that is physically coupled to actuated element 520. As depicted, scale 510 spans the length of actuated element 520. However, scale 510 may be longer or shorter than actuated element 520, so long as it is at least as long as the distance covered by the range over which actuated element 520 is configured to move. Scale 510 may be printed or otherwise formed on actuated element 520 directly, physically attached to actuated element 520, or physically attached to a moving component of actuator 530. Except for the fact that scale 510 moves with actuated element 520, scale 510 may otherwise be like scale 410, including in that scale 510 is covered with colored markings arranged as gradients between primary colors 512-516

Encoder 500 further comprises a sensor 550. In contrast to scale 510, sensor 550 is held in a fixed or stationary position by an arm 552 or other structural component that does not move with actuated element 520. For instance, sensor 550 may be physically attached to a housing of encoder 500 or to a non-moving component of actuator 530. Sensor 550 is similar to sensor 450. However, in encoder 500 it is scale 510 that is moving instead of sensor 550.

As with sensor 450, sensor 550 is oriented towards scale 510 and configured to detect the color of a marking at a particular point in space in front of sensor 550. As scale 510 moves linearly through this particular point, sensor 550 will detect different colors. Sensor 550 outputs an indication of the color it detects, as described with respect to other sensors herein, via wiring 558.

Encoder 500 further comprises a controller 540, similar to controller 440. Controller 540 receives the color information via wiring 558, and then determines the position of the actuated element 520 based on the detected color. As with controller 440, controller 540 may then output this position to another component that is coupled internally or externally to controller 540 or perform any of a variety of other actions based on that position.

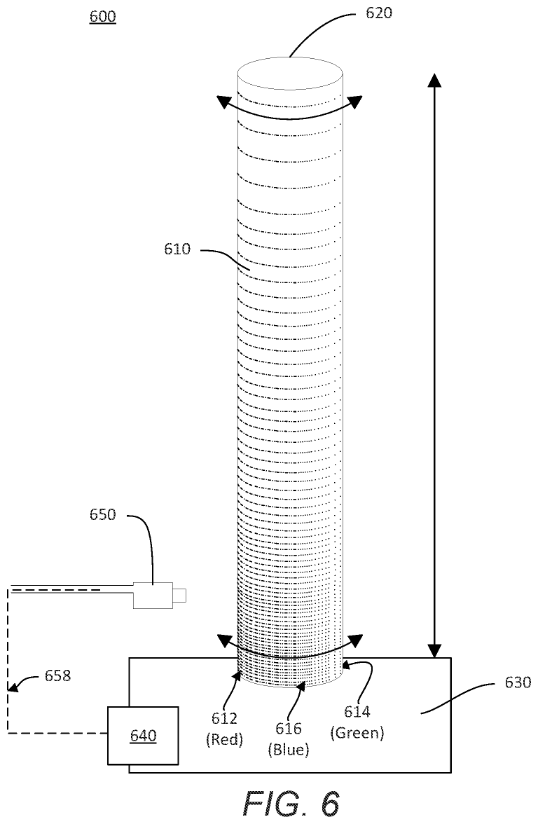

Some examples can use a combination rotary and linear encoder. For example, FIG. 6 is an illustrative view of an example combination rotary and linear encoder mechanism 600, according to an embodiment. Encoder mechanism 600, or simply encoder 600, measures both the linear position and angular position of a shaft 620. Shaft 620 is configured both to rotate around and to move linearly along a range of positions on an axis vertical to FIG. 6. Shaft 620 is actuated by an actuator 630, which may comprise any combination of linear, rotary, or other type of actuator mechanism capable of actuating shaft 620 both linearly and rotationally. Although shaft 620 is depicted as cylindrical, shaft 620 may take other shapes, in the same manner as shaft 120. Optionally, shaft 620 may be coupled to one or more other components (undepicted) that move with shaft 620.

Some examples can use a two-dimensional scale. For example, a two-dimensional scale 610 is formed on or in the surface of shaft 620, so that scale 610 rotates and moves with shaft 620. Scale 610 includes color markings similar to those in scale 110, with markings having different colors depending on the absolute angular positions that correspond to those markings. Again, the color markings are arranged to form gradients between primary colors red 612, green 614, and blue 616. The scale 610 may employ any variation on this color marking scheme described herein.

However, unlike previously described scales, the color markings also vary based on the linear position to which they correspond. For any given angular position, the color markings along the linear axis change gradually with respect to one or more color appearance parameters as the distance of the marking from a point of origin increases, thereby creating a linear gradient in addition to the rotary gradient(s). For instance, the red color 612 may be the base color used for all markings at the polar angle θ, but may be printed at full brightness for the linear position of 0, 75% brightness at the linear position of 50, and only half brightness for the linear position of 100. This marking scheme is represented in FIG. 6 by changing the frequency of markings with linear distance, though it will be understood that this convention is merely illustrative and not intended to require that the marking frequency actually change with distance. Markings may vary linearly in accordance with any of a variety of color appearance parameters. For instance, the color appearance parameter may be without limitation hue, lightness, brightness, chroma, colorfulness, saturation, or contrast. In an embodiment, the modified color appearance parameter may be any color appearance parameter defined by a suitable color appearance model, such as without limitation CIELAB or CIECAM02 (as defined by the International Commission on Illumination, as of the priority date of this application).

More generally, in other embodiments, each color marking in scale 610 has a two-dimensional position coordinate with respect to the outside surface of shaft 620 in terms of angular position and linear position. Each angular position is assigned a base color (e.g., a color coordinate in an RGB color space). Each linear position is assigned a transformation based on a color appearance parameter. For instance, the transformation may be adjusting saturation by an amount proportional to the distance of that linear position from an origin. The color of a given marking, then, is taken by transforming the base color assigned to the angular position of the marking using the transformation that corresponds to the linear position of that marking.

In yet other embodiments, this scheme may be inverted. For instance, gradients between red and green, and between green and blue, may span the linear axis of the scale 610, while the color for any given linear position may change rotationally in accordance with a color appearance parameter. In yet other embodiments, scale 610 may more generally comprise markings whose colors are arranged two dimensionally on the surface of the shaft 620 substantially in the same manner as a grid within a particular color model. Yet other similar arrangements may be utilized.

In an embodiment, when selecting a color marking scheme for the two-dimensional scale, care should be taken to ensure that no two color markings have the same color. However, in another embodiment, a sensor 650, or multiple such sensors, may read multiple markings concurrently. Each coordinate in the scale 610 may have its own unique signature of sampled color markings that would be sampled concurrently, even if some markings have the same color.

Different examples can implement position determination in different ways. For example, similar to other encoders described herein, encoder 600 comprises a sensor 650 which detects the color of a marking on scale 610 in front of sensor 650 and sends an indication of the color to a controller 640 via wiring 658. Sensor 650 is like sensor 550, including in that sensor 650 is stationary and does not move with shaft 620. Encoder 600 is similar to other encoders described herein, and discussion above correspondingly similarly applies, except that the encoder 600 implements a mapping of color to two-dimensional coordinate positions. That is, each color is mapped to both an angular position and linear position, consistent with the color marking scheme described above. The mapping may be a table, function, combination thereof, or any other suitable mapping mechanism.

Some implementations can compensate for operating environment changes. For example, changes to the operating environment in which an encoder functions, such as lighting changes, dust build-up, or normal wear and tear, may cause the sensor to detect different colors for the same position over time. Another difficulty may be that manufacturing, printing, or other inconsistencies may result in different encoders having slightly different color-to-position profiles. In some embodiments, an encoder may compensate for these and other problems by applying a color correction transformation to the detected color and determining the encoder position from the transformed color as opposed to the originally detected color. Any of a variety of color correction and compensation techniques may be utilized to determine a suitable transformation.

For example, in an embodiment, an appropriate color correction transformation may be determined using readings from one or more calibration areas on the scale. The calibration areas may be of a common color. For instance, a wheel-shaped track along the outside or inside of a rotary scale may be colored a certain shade of purple. Or a ribbon along the bottom of a linear scale may be colored a certain shade of orange. In an embodiment, a background color of the scale medium itself may be used for calibration. Readings from both the calibration area and the gradient area of the scale may be taken substantially concurrently by the same sensor (e.g., from different portions of the same image), or by different sensors. The controller may be configured to determine a transformation, such as a change in brightness, contrast, saturation, and so forth, that should be applied to the reading from the calibration area to yield the color that the controller expects to read from the calibration area. The controller may then apply this same transformation to the reading from the gradient area.

In an embodiment, an appropriate color correction transformation may be determined using readings from multiple scale positions on the color gradient concurrently. One or more sensors may be configured to read from fixed scale positions that are a certain number of degrees or units apart from each other. The readings may or may not include a reading from the scale position that corresponds to the position that the encoder is configured to output (i.e., the encoder position). The readings may be taken from relative scale positions such that, when an operating environment change has occurred, and has had a similar impact on each color marking, it would be unlikely in a multiple-gradient scale that any set of readings so taken would be consistent with the mapping scheme implemented by the controller. That is, the set of colors read by the sensor(s) may fail to match those expected for any set of positions spaced at the same relative distances from each other as the sensor(s) are configured to read. Therefore, if the readings are in fact inconsistent, the controller may determine that an operating environment change has occurred, and then employ color-correction algorithms to identify a transformation by which the set of colors that was actually read can be converted to a set of colors that is consistent with the mapping scheme for the corresponding positions. The controller may then use, and optionally continue to use, this transformation for color-correction.

In another embodiment, an encoder features a mapping scheme that maps a set of colors read from different positions on the scale to a single encoder position. If the readings at any given time are not consistent with the mapping scheme, the controller attempts various color correction algorithms on the readings until the corrected readings match a set of colors that is mapped to an encoder position.

Some examples can be configured for self-calibration. For example, as an alternative or addition to color compensation techniques as described above, an encoder controller may include logic for a self-calibration routine, by which the controller generates or updates the mapping table or function that it implements for mapping colors to positions. Depending on the embodiment, the controller may perform such calibration periodically, upon request (e.g., in response to input via a calibration interface), or in response to detecting changes in the operating environment, such as changes in overall light levels, unexpected color readings or sequences of color readings, movement of an assembly in which the encoder is housed, and so forth.

To perform such self-calibration, the controller is electronically coupled to an actuator that drives the element whose position the encoder is configured to determine. The controller causes the actuator to move the element at a consistent or predictable speed. As the actuator does so, the controller repeatedly collects color readings from the encoder's sensor. The controller builds a new mapping table or function based on the colors it reads and when those colors were read relative to a complete traversal or cycle of the scale. The calibration may be performed multiple times to compensate for power fluctuations or other sources of variation in the speed of the actuator. Knowledge of the encoder's original mapping function or table may further inform the encoder's calibration routine by indicating what the distance should be between each primary color, how many total discrete colors should be found in a gradient, what the original colors were, and so forth.

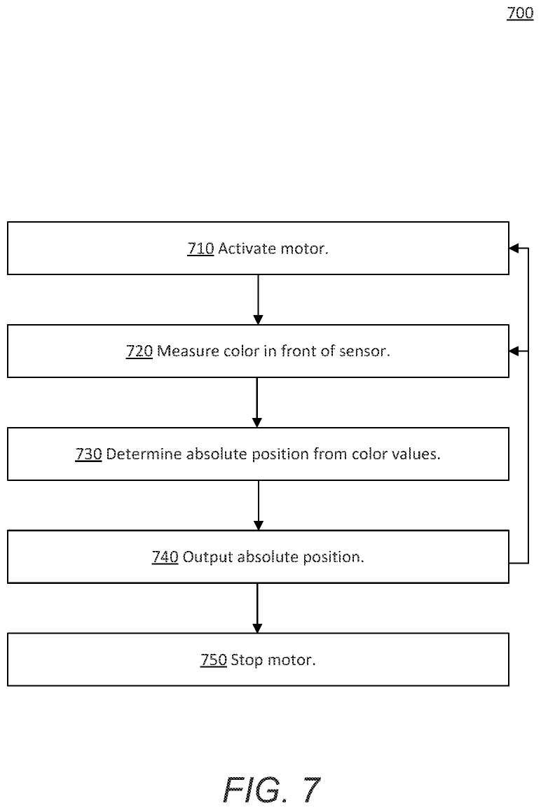

FIG. 7 is a block diagram 700 illustrating an example process flow (and functional overview) for utilizing a gradient-based encoder, according to an embodiment. The illustrative process flow may be used in conjunction with encoder mechanisms such as described herein, though it will be understood that the encoder mechanisms may also or instead be utilized in conjunction with other process flows.

The process flow comprises blocks 710-750. Block 710 comprises activating a motor, thereby causing movement in a shaft or other actuated element. Block 720 comprises measuring color values on a color scale. The scale has different markings corresponding to different angular or linear positions, as in scale 110, 310, 410, 510, or 610. In particular, one or more sensors, such as sensor 150, may measure the color of a marking positioned directly in front of the one or more sensors, optionally in coordination with a lighting mechanism that reflects light off the scale or passes light through the scale. One of either the sensor or the scale is attached to the actuated element, while the other of the sensor or the scale is stationary. Hence, as the actuated element moves, the color in front of the sensor will change, resulting in different color measurements. The color may be measured using any suitable color encoding system, such as in terms of red, green, and blue coordinates.

In an embodiment, the measuring process simply comprises taking a single color reading from a color sensor. In other embodiments, the measurement process may involve additional steps at the sensor, or at computing hardware or other circuitry communicatively coupled to the sensor, such as at a controller like controller 140. Such additional steps may include, for instance, transforming color values based on calibration feedback, averaging multiple readings from multiple sensors to determine the measured color, performing image processing algorithms, identifying specific pixel(s) in an image to take the color measurement from, averaging or performing other mathematical operations with respect to those pixels, and so forth.

Block 730 comprises determining an absolute position based on the color measurement. The determination may be made, for instance, by computing hardware or other circuitry communicatively coupled to the sensor after receiving the color measurement from the sensor or after processing image or other color information received from the sensor to determine the final color measurement. The determination may comprise, for instance, inputting color values from the measurement, such as red, green, and blue coordinates, into a mapping function that outputs an absolute position. Or the determination may comprise looking up the values in a lookup table that maps values to coordinates, optionally with interpolation between rows if the exact set of color values is not found. The determined position may be a linear position, an angular position, or a combination thereof.

Block 740 comprises outputting the absolute position to a downstream device, such as without limitation a data collector, server, PLC, display device, or edge controller. In an embodiment, such a device may be configured to display the absolute position. In an embodiment, such a device may be configured to perform another action based on the position. For example, the downstream device may include logic that, based on a comparison of the absolute position to a desired position, returns to block 710 to activate the motor again, or proceeds to block 750, which comprises stopping the motor. The downstream device may also or instead instruct or cause other devices to perform actions based on the outputted position, including without limitation alarm devices, control valves, other actuators, and so forth.

Various extensions and alternatives are possible. For example, block diagram 700 illustrates but one example process flow for using a gradient-based encoder. Other process flows may include additional or fewer blocks, or different arrangements of the blocks therein. For instance, instead of activating a motor, block 710 may comprise activating another actuator mechanism. As another example, the controller that determines the absolute position may cause performance of actions at the actuator or at other devices without outputting the absolute position downstream.

Moreover, encoders 100, 300, 400, 500, and 600 illustrate only some of the many encoders possible utilizing the techniques and mechanisms described herein. Other such encoders may comprise fewer, additional, or different components in varying arrangements.

In an embodiment, a spiraling color scale may be used on a screw-like component. The spiraling color scale may be similar to the linear scales described herein, except that the spiraling color scale follows the spiraling contours of the threads (or gap between threads) in the screw.

In an embodiment, rather than generating an explicit mapping table, machine learning techniques may be utilized to learn positions. A sensor captures an image of the area on the scale directly in front of the sensor. The controller passes the image, or a pre-processed version thereof, into a machine learning model generated for the encoder mechanism. The model outputs a corresponding absolute position for the inputted image. Such a model may be learned using standard training techniques, based on a dataset comprising images of the scale and corresponding absolute positions. The model may be learned for each encoder separately as part of an initial calibration process, or the model may be loaded into a controller after having been learned from data supplied by other encoders of the same manufacture.

In an embodiment, to provide for more high-grained granularity (e.g., with respect to a linear actuator with long travel), multiple tracks of gradients may be used on the scale, each corresponding to a different unit (e.g., millimeter, centimeter, meter, etc.) of the position. A first track with large, expanded markers may be used to resolve a largest position unit. Smaller tracks might repeat the color marking scheme an increasing number of times with increasingly smaller or condensed markers for resolution of smaller position units. The tracks may be read by a same sensor, or different sensors. The controller may determine a quantity of each unit based on the track corresponding to that unit, and then combine the units together to produce a single encoder position.

Although numerous examples are shown and described herein, those of skill in the art will readily understand that details of the various embodiments need not be mutually exclusive. Instead, those of skill in the art upon reading the teachings herein should be able to combine one or more features of one embodiment with one or more features of the remaining embodiments. Further, it also should be understood that the illustrated embodiments are exemplary only and should not be taken as limiting the scope of the inventive subject matter. All methods described herein can be performed in any suitable order unless otherwise indicated herein or otherwise clearly contradicted by context. The use of any and all examples, or exemplary language (e.g., “such as”) provided herein, is intended merely to better illuminate the aspects of the exemplary embodiment or embodiments of the inventive subject matter, and do not pose a limitation on the scope of that subject matter. No language in the specification should be construed as indicating any non-claimed element as essential to the practice of the inventive subject matter.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some examples, aspects of the disclosed technology, including computerized implementations of methods according to the disclosed technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, configurations of the disclosed technology can be implemented as a set of instructions, tangibly embodied on a non-transitory computer-readable media, such that a processor device can implement the instructions based upon reading the instructions from the computer-readable media. Some examples of the disclosed technology can include (or utilize) a control device such as an automation device, a special purpose or general purpose computer including various computer hardware, software, firmware, and so on, consistent with the discussion below. As specific examples, a control device (e.g., controller) can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some examples, a control device can include a centralized hub controller that receives, processes and (re) transmits control signals and other data to and from other distributed control devices (e.g., an engine controller, an implement controller, a drive controller, etc.), including as part of a hub-and-spoke architecture or otherwise.

Certain operations of methods according to the invention, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the invention. Further, in some examples, certain operations can be executed in parallel, including by dedicated parallel processing devices, or separate computing devices configured to interoperate as part of a large system.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

Although the presently disclosed technology has been described with reference to preferred examples, workers skilled in the art will recognize that changes may be made in form and detail to the disclosed examples without departing from the spirit and scope of the concepts discussed herein.

1. An assembly comprising:
a shaft rotatable around a first axis;
a scale comprising a color wheel that represents absolute angular positions relative to a point at which the first axis intersects the color wheel, the color wheel having at least one gradient between a plurality of colors, each color of the plurality of colors in the gradient corresponding to a different angular position;
a color sensor configured to measure a color of the color wheel at a particular position in front of the color sensor; and
a controller configured to output an angular position signal representing an angular position of the shaft based on the color measured by the color sensor.

2. The assembly of claim 1, wherein the color sensor is coupled to the shaft and thereby configured to rotate with the shaft while the color wheel remains stationary relative to the first axis, such that the particular position measured by the color sensor changes as the shaft rotates.

3. The assembly of claim 1, wherein the scale is coupled to the shaft and thereby configured to rotate with the shaft while the color sensor remains stationary relative to the first axis, such that the color of the color wheel at the particular position measured by the color sensor changes as the shaft rotates.

4. The assembly of claim 1, wherein angular positions represented by the gradient increase as the gradient progresses from a first color to a second color.

5. The assembly of claim 1, wherein the color wheel comprises a first gradient between a first color and a second color, a second gradient between the second color and a third color, and a third gradient between the third color and the first color.

6. The assembly of claim 1, wherein the color wheel comprises a first arc having a first gradient between a red color and a green color, a second arc having a second gradient between the green color and a blue color, and a third arc having a third gradient between the blue color and the red color.

7. The assembly of claim 1,
wherein the color sensor is configured to output to the controller an indication of the color at the particular position as a measurement in a color space comprising at least three components;
wherein the controller is configured to convert the measurement into the angular position based on a mapping from the color space to a polar angle.

8. An assembly comprising:
a linearly actuatable element movable along a first axis;
a color scale representing absolute linear positions on a line segment that is parallel to the first axis, the color scale having at least one gradient between a plurality of colors, each color of the plurality of colors in the gradient corresponding to a different linear position;
a color sensor configured to measure a color of the color scale at a particular position in front of the color sensor; and
a controller configured to output a linear position signal representing a linear position of the linearly actuatable element based on the color measured by the color sensor.

9. The assembly of claim 8, wherein the color sensor is coupled to or included in the linearly actuatable element and thereby configured to move along the first axis with the linearly actuatable element while the color scale remains stationary relative to the first axis, such that the particular position measured by the color sensor changes as the linearly actuatable element moves along the first axis.

10. The assembly of claim 8, wherein the color scale is coupled to or included in the linearly actuatable element and thereby configured to move along the first axis with the linearly actuatable element while the color sensor remains stationary relative to the first axis, such that the color of the color scale at the particular position measured by the color sensor changes as the linearly actuatable element moves.

11. The assembly of claim 1, wherein linear positions represented by the gradient increase as the gradient progresses from a first color to a second color.

12. The assembly of claim 8, wherein the color scale comprises a first gradient between a first color and a second color, a second gradient between the second color and a third color, and a third gradient between the third color and the first color.

13. The assembly of claim 8, wherein the color scale comprises a first segment having a first gradient between a red color and a green color and a second segment having a second gradient between the green color and a blue color.

14. The assembly of claim 8,
wherein the color sensor is configured to output to the controller an indication of the color at the particular position as a measurement in a color space comprising at least three components;
wherein the controller is configured to convert the measurement into the linear position based on a mapping from the color space to a measure of distance from an origin.

15. An assembly comprising:
a shaft that is both rotatable around a first axis and movable along a length of the first axis, the shaft having an exterior surface colored in such manner that each surface position of a plurality of surface positions has a unique color;
a color sensor configured to measure a color of the exterior surface at a particular position in front of the color sensor; and
a controller configured to, based on the color measured by the color sensor, output a position signal representing a coordinate of the shaft in terms of: angular position relative to the first axis, and linear position along the first axis.

16. The assembly of claim 15,
wherein the controller is configured to calculate the angular position based on a color coordinate of the color in a color space;
wherein the controller is configured to calculate the linear position based on a color appearance parameter in a color appearance model.

17. The assembly of claim 15, wherein at each angular position of a plurality of angular positions relative to the first axis, the exterior surface is colored a shade of a particular color mapped to that angular position, the shade increasing in one or more or intensity, brightness, luminance, or lightness in accordance with distance from an origin along the first axis.

18. The assembly of claim 15,
wherein at each angular position of a plurality of angular positions relative to the first axis, the exterior surface is colored a shade of a particular color mapped to that angular position, the shade increasing in one or more or intensity, brightness, luminance, or lightness in accordance with distance from an origin along the first axis;
wherein the particular color mapped to each angular position of the plurality of angular positions progresses in a gradient from a first color to a second color as the angular position increases from a first position to a second position.

19. The assembly of claim 15,
wherein for each cross-section of a plurality of horizontal cross-section of the shaft, the exterior surface indicates angular positions using at least one gradient, in which the angular positions increase as the gradient progress from a first color to a second color;
wherein each cross-section has a different first color and a different second color, selected from a first color appearance gradient and a second color appearance gradient, respectively, based on a linear position of the cross-section along the first axis.

20. The assembly of claim 15,
wherein each angular position in a plurality of angular positions of a first arc of the exterior surface is mapped to a different color in a first gradient from a red color to a green color;
wherein each angular position in a plurality of angular positions of a second arc of the exterior surface is mapped to a different color in a second gradient from the green color to a blue color;
wherein each angular position in a plurality of angular positions in a third arc of the exterior surface is mapped to a different color in a third gradient from the blue color to the red color;
wherein locations on the exterior surface are colored with shades of the different colors that are mapped to the angular positions of the locations on the exterior surface, the shades progressing in brightness, intensity, or lightness relative to the linear positions of the locations on the exterior surface.
